(19) United States
(12) Patent Application Publication
(10) Pub. No.: US 2012/0036750 A1
(43) Pub. Date: Feb. 16, 2012

(54) Internally Illuminated Panel and Method of Making the Same

(75) Inventor: Lee Sang Ryul, Gyeonggi-do (KR)

(73) Assignee: SUN INNO TECH, Gyeonggi-do (KR)

(21) Appl. No.: 12/855,121

(22) Filed: Aug. 12, 2010

(51) Int. Cl. G09F 13/18; B23P 19/04

(52) U.S. Cl. 40/546; 29/460

(57) ABSTRACT

Embodiments of internally illuminated panels and methods for making such panels are disclosed herein. In general, the internally illuminated panel includes a transparent plate having a front surface and a back surface, a channel formed within the back surface of the transparent plate, and an illumination source embedded within the channel for directing illumination into an interior of the transparent plate. Unlike conventional panel designs, a pattern of grooves is formed across the back surface of the transparent plate for reflecting and refracting the internal illumination in a predetermined and predictable manner. In particular, characteristics of the pattern (such as the spacing and depth of the grooves) are configured to provide uniform distribution and intensity of the internal illumination emitted from the internally illuminated panel.

### BACKGROUND OF THE INVENTION

1. Field of the Invention

This invention relates to internally illuminated panels and, more particularly, to panels that are lit with internally embedded LEDs and have waterproofing features, which protect the panels from moisture. In one application, the internally illuminated panels may be implemented as traffic signs, road signs, advertising signs, billboards, store-front signs, signs indicating house/building/room numbers, etc. However, the internally illuminated panels described herein are not limited to signage, and may be applicable to many different indoor and outdoor lighting applications that would benefit from a uniformly lit panel, which is substantially impervious to moisture.

2. Description of the Related Art

The following descriptions and examples are given as background only.

Illuminated signs are used in a wide variety of applications including, but not limited to, traffic signs, road signs, directional signs, advertising signs, billboards, store-front signs, and signs indicating house/building/room numbers. Traditionally, these signs would be illuminated externally using standard light bulbs of various sorts (e.g., incandescent, fluorescent and neon bulbs). Signs employing standard light bulbs can be illuminated from the front by reflecting light off the front face of the sign, or from the back by transmitting light through sign indicia. Disadvantages of such signs include low energy efficiency and limited lifetime of the standard light bulbs used to illuminate the sign. In addition, the light generated by the standard light bulbs may be uncomfortably bright in some cases, but may not adequately illuminate the sign in other cases.

The use of light emitting diodes (LEDs) to illuminate signs has been proposed, as LEDs provide many advantages over conventional light sources including lower energy consumption, longer lifetime, improved robustness, smaller size, and greater durability and reliability. In some conventional signs, LEDs are positioned around peripheral edges of an optically transparent plate, typically within a metal or plastic frame surrounding the peripheral edges of the plate. Illumination from the LEDs is directed into the optically transparent plate, reflected off a reflective coating or film applied to a rear surface of the plate and emitted from a front surface of the plate. In some cases, sign indicia may be applied to the front surface of the plate by painting portions of the front surface with an optically opaque paint, or by applying an optically opaque layer having select cut-out portions.

However, conventional signs are currently lacking in a variety of ways. For instance, many conventional signs suffer from the so-called “dot phenomenon” produced by LED spot radiation. The dot phenomenon occurs when LED illumination is not uniformly distributed across the transparent plate, causing areas near the LEDs to be intensely illuminated, while areas further away from the LEDs are only weakly illuminated. In some designs, one surface of the transparent plate may be roughed (e.g., sandblasted), or an optical diffusion sheet may be applied to the one surface of the transparent plate, to diffuse the illumination. While such designs lessen the effects of the dot phenomenon, they undesirably lower the optical efficiency of the illuminated sign and limit the intensity of light emitted there from.

Another disadvantage of conventional signs is that they fail to provide a rugged design suitable for a variety of environmental conditions, including both indoor and outdoor applications. Some designs, which claim to be waterproof, use adhesive tape to assemble various layers of the sign. However, these designs either fail to adequately seal the layers so as to provide a completely waterproof design and/or fail to address the temperature differential, which is often generated between interior and exterior surfaces of the sign. For instance, a temperature difference may develop between interior and exterior surfaces of the sign in hot weather conditions or as a result of the heat, which is generated internally by the LEDs. In some cases, the temperature difference between the interior and exterior surfaces of the sign may cause condensation or moisture to develop within the sign, despite the sign's waterproofing features. Regardless of how the moisture enters the sign (i.e., through ingress of moisture from the outside environment or through internally generated condensation), any amount of internal moisture is undesirable as it will cause the illumination circuitry to rust and the LEDs to ultimately fail.

A need, therefore, remains for an internally illuminated panel or sign, which overcomes the disadvantages inherent to currently available designs. In particular, a need remains for an internally illuminated panel or sign, wherein optical efficiency and illumination intensity are increased by uniformly distributing the illumination across an emitting face of the sign in a predetermined and predictable manner. In addition, a need remains for an internally illuminated panel or sign, which is impervious to moisture. Such a need is met by the internally illuminated panel described herein.

### SUMMARY OF THE INVENTION

The following description of various embodiments of internally illuminated panels and methods of making such panels are not to be construed in any way as limiting the subject matter of the appended claims.

According to one embodiment, an internally illuminated panel is provided herein for uniformly distributing the internal illumination across an emitting face of the panel, thereby increasing the optical efficiency and intensity of the light emitted from the panel. In general, the internally illuminated panel may comprise a transparent plate having a front surface and a back surface, a channel formed within the back surface of the transparent plate, and an illumination source is embedded within the channel for directing illumination into an interior of the transparent plate. Preferably, the illumination source comprises a string of light emitting diodes (LEDs) mounted with associated circuitry onto a flexible backing material.

The internally illuminated panel may also comprise a reflective layer coupled to the back surface of the transparent plate for reflecting portions of the internal illumination towards the front surface of the transparent plate, and a heat conductive layer coupled to the reflective layer for conducting heat generated by the illumination source away from the internally illuminated panel. As described in more detail below, the heat conductive layer may help to reduce or eliminate a temperature differential that may exist between interior and exterior surfaces of the panel.

In some embodiments, the internally illuminated panel may comprise an opaque or semi-transparent layer coupled to the front surface of the transparent plate, wherein the opaque or semi-transparent layer comprises indicia configured for selectively transmitting the illumination emitted from the front surface of the transparent plate. The type of indicia is substantially unlimited and may comprise decorative designs, numbers, letters, characters, logos, images and any other indicia, which is used to convey information or provide decoration. In some embodiments, the indicia may be formed by removing select portions of the opaque or semi-transparent layer (e.g., by etching, routing, or stamping the layer to remove the select portions), or by forming the indicia concurrently with the formation of the opaque or semi-transparent layer (such as during a molding or casting process). In other embodiments, the indicia may comprise a semi-transparent film (containing, e.g., an image to be illuminated), which is superimposed onto an underlying transparent layer.

In one embodiment, the channel may be formed near peripheral edges of the transparent plate along an entire circumference of the back surface. This embodiment is generally useful in smaller panel designs (e.g., panel diameters up to about 1 m²), in which the illumination source can be configured to illuminate substantially the entire panel. In other embodiments, the channel may be formed within the back surface of the transparent plate, such that the channel surrounds peripheral edges of the indicia to be illuminated, rather than the edges of the panel. This embodiment finds utility in larger panel designs (e.g., panel diameters substantially greater than 1 m²), which cannot be successfully illuminated by a circumferentially embedded illumination source. While the channel may be formed in substantially any manner known in the art (e.g., by etching, routing, etc.), the channel is generally formed as rectangular shaped notch having a depth, which is sufficient to accommodate the embedded illumination source. Alternatively shaped notches may also be used when forming the channel.

To increase the uniformity and intensity of the light emitted from the internally illuminated panel, a pattern of grooves is formed across the back surface of the transparent plate for reflecting and refracting the internal illumination in a predetermined and predictable manner. In one embodiment, the grooves may extend from opposite sides of the back surface in a plurality of rows and columns. While the grooves may be formed in substantially any manner known in the art (e.g., by etching, routing, etc.), they are generally formed to resemble an inward facing “V” shaped notch. Alternatively shaped notches may also be used when forming the grooves.

The pattern of grooves comprise certain characteristics, which are chosen to provide uniform distribution and intensity of the light emitted from the front surface of the transparent plate. In one embodiment, the pattern characteristics may include a spacing between consecutive grooves, as well as a depth of the grooves. In order to provide uniform distribution of the emitted light, the spacing between consecutive grooves preferably decreases with increasing orthogonal distance from the illumination source. To increase the brightness or intensity of the emitted light, the depth of the grooves should be selected based on the thickness of the transparent plate. Specifically, the depth of the grooves should increase with increasing thickness of the transparent plate.

In addition to superior light output, means are provided for weatherproofing the internally illuminated panel, thereby protecting the illumination source and circuitry embedded therein. In some embodiments, such means may comprise a first waterproof material coating the illumination source, a second waterproof material covering the channel and the illumination source embedded therein, a third waterproof material for coupling the reflective layer to the back surface of the transparent substrate, and a fourth waterproof material for coupling the heat conductive layer to the reflective layer. If an opaque or semi-transparent layer is included within the panel, said means may also comprise a fifth waterproof material for coupling the opaque or semi-transparent layer to the front surface of the transparent plate. When used in conjunction, such means provide a rugged, waterproof design suitable for a variety of environmental conditions, including both indoor and outdoor applications.

A method for manufacturing an internally illuminated panel is also provided herein. According to one embodiment, the method may comprise forming a channel and a pattern of grooves within a back surface of a transparent plate. The channel and grooves may be formed in subsequent or concurrent fabrication steps as described further herein. Sometime after the channel and grooves are formed, an illumination source may be embedded within the channel, so that illumination from the source will be directed into the transparent plate along a plane substantially parallel to the back surface. Before the illumination source is embedded, however, it is generally desirable to coat the illumination source with a first waterproof material (e.g., a waterproofing liquid) and allow the coated illumination source to dry. This represents a first waterproofing step.

After the illumination source is embedded within the channel, the channel is sealed with a second waterproof material in a second waterproofing step. A reflective layer is subsequently coupled to the back surface of the transparent plate using a third waterproof material, and a heat conductive layer is subsequently coupled to the reflective layer using a fourth waterproof material. If an opaque or semi-transparent layer is included within the panel, the opaque or semi-transparent layer may be coupled to a front surface of the transparent plate using a fifth waterproof material. Unlike the first waterproofing step (which uses a special waterproofing liquid), the second, third, fourth and fifth waterproofing steps may utilize an adhesive tape, silicone binder or other waterproof adhesive material.

### BRIEF DESCRIPTION OF THE DRAWINGS

Other objects and advantages of the invention will become apparent upon reading the following detailed description and upon reference to the accompanying drawings in which:

FIG. 1 is a view illustrating a front face of an internally illuminated panel in accordance with one embodiment of the invention;

FIG. 2 is an exploded cross-sectional view taken along line AA of FIG. 1 illustrating various layers that may be included within the internally illuminated panel;

FIG. 3 is a view illustrating a transparent plate that may be included within the internally illuminated panel, wherein the transparent plate comprises a pattern of grooves that extend from opposite sides of the back surface of the transparent plate in a plurality of evenly spaced rows and columns;

FIG. 4 is a view illustrating another transparent plate that may be included within the internally illuminated panel, wherein the transparent plate comprises a pattern of grooves configured to provide a uniform distribution and intensity of the illumination;

FIG. 5A is a graph illustrating one manner in which the spacing between consecutive grooves in the pattern shown in FIG. 4 may decrease with increasing orthogonal distance from the illumination source to provide a more uniform distribution of light;

FIG. 5B is a graph illustrating one manner in which the depth of the grooves may increase with increasing thickness of plate to maximize the intensity of light emitted from the panel;

FIGS. 6A-E are cross-sectional views illustrating one embodiment of a method that may be used for fabricating the internally illuminated panel;

FIGS. 6F-H are cross-sectional views illustrating additional or alternative steps that may be performed to fabricate alternative embodiments of the internally illuminated panel;

FIG. 7 illustrates an exemplary method for coating an illumination source with a waterproof material and allowing the coated illumination source to dry before the illumination source is embedded within the channel;

FIG. 8 illustrates an alternative embodiment of an internally illuminated panel, in which illumination is emitted from both sides of the panel; and

FIGS. 9-10 illustrate another alternative embodiment of an internally illuminated panel, in which the channel formed within the back surface of the transparent plate surrounds peripheral edges of the indicia to be illuminated, rather than the edges of the panel.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF PREFERRED EMBODIMENTS

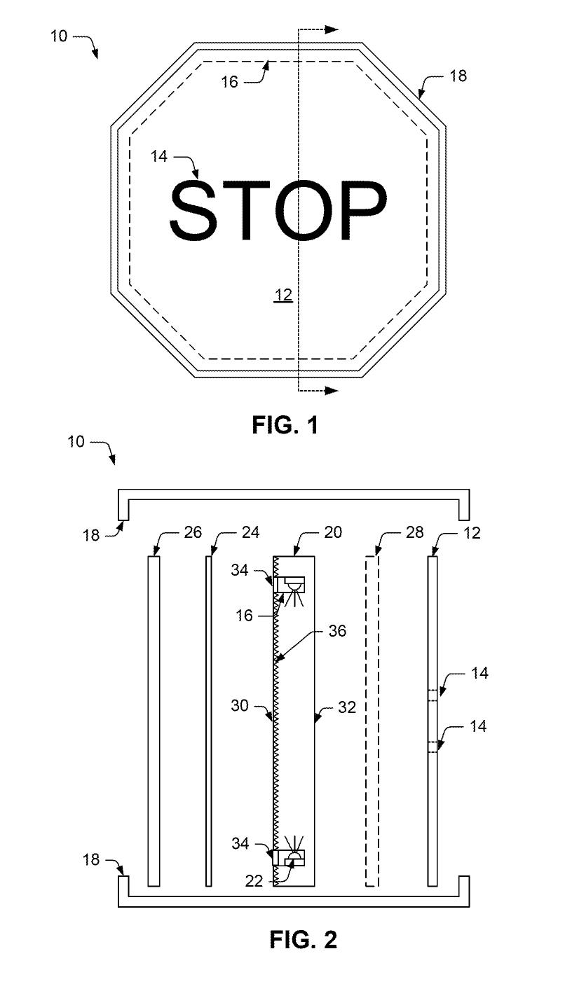

Turning now to the drawings, FIGS. 1-10 illustrate preferred embodiments of an internally illuminated panel, and methods for making such a panel, in accordance with the present invention. As will become apparent in the description set forth below, the preferred embodiments illustrated in FIGS. 1-10 improve upon conventional designs by providing uniform distribution and maximum intensity of the illumination emitted from the internally illuminated panel. In addition, means are provided for weatherproofing the panel and protecting the illumination source and circuitry embedded therein. Such means provide a highly rugged and robust design suitable for a variety of different environmental conditions, including indoor and outdoor applications.

As used herein, the term “internally illuminated panel” may be used to describe a wide variety of interior and exterior lighting devices including signs, decorative panels and other sources of illumination. Although aspects of the invention are described herein with respect to a sign (and in particular, a traffic sign), the internally illuminated panel described herein is not limited to signage, and may be applicable to any indoor or outdoor lighting application that would benefit from a uniformly lit panel, which is substantially impervious to moisture and other environmental conditions. In addition to lending itself to a wide variety of indoor or outdoor lighting applications, the internally illuminated panel described herein may be implemented in a wide variety of shapes and sizes. In fact, the methods described herein may be used to fabricate substantially any shape and/or size of panel.

It is noted that the some of the figures described herein are not drawn to scale. In particular, the scale of some of the elements of the figures are greatly exaggerated to emphasize characteristics of the elements. It is also noted that some of the figures are not drawn to the same scale. Elements shown in more than one figure that may be similarly configured have been indicated using the same reference numerals. Some elements of the internally illuminated panel (such as the circuitry used to power the panel or the means used to attach the panel to surface) have not been included in the figures for the sake of clarity.

FIGS. 1-3 illustrate one exemplary embodiment, in which an internally illuminated panel 10 in accordance with the invention is implemented as a STOP sign. A front face of sign 10 is depicted in FIG. 1 as including top layer 12 having indicia 14 (e.g., “STOP”), which are illuminated by an illumination source embedded within channel 16 formed in an underlying layer of panel 10. Top layer 12 may comprise a variety of different material compositions and thicknesses and, thus, may be generally referred to as a plate or film. In one embodiment, the material composition of layer 12 may be chosen from a variety of thermoplastic polymers including, but not limited to, polycarbonate (PC), Polyethylene terephthalate (PET), and acrylic materials. In one embodiment, the thickness of top layer 12 may range between about 1 mm and about 5 mm.

Top layer 12 is configured for selectively transmitting the illumination emitted from the internally illuminated panel. In most cases, top layer 12 is formed from an opaque or semi-transparent plate or film. In one embodiment, indicia 14 may be formed by removing select portions of layer 12 (e.g., by cutting, etching, routing or stamping layer 12). In another embodiment, indicia 14 may be formed concurrently with the formation of layer 12 (such as during a molding or casting process). In yet another embodiment, indicia 14 may be formed by printing an image or other feature to be illuminated onto layer 12. If top layer 12 comprises a film, the top layer may, in some embodiments, be superimposed onto an underlying transparent layer 28 (shown in outline in FIG. 2). Although illustrated as letters in FIG. 1, indicia 14 may comprise substantially any decorative or information-bearing design, such as numbers, letters, characters, logos, images, other decorative designs, and/or combinations thereof.

It is worth noting that layer 12 comprising indicia 14 and underlying layer 28 are optional features of the internally illuminated panel 10 described herein. For instance, layers 12/28 may not be included within the internally illuminated panel 10 if the panel is used solely as a source of illumination (such as a light fixture or an illuminated panel incorporated within a wall, ceiling or floor), rather than a decorative or information-bearing device. In most embodiments, however, layer 12 may be coupled with one or more additional layers forming a “sandwich” of similarly shaped layers. In some embodiments, the “sandwich” of layers may be encased within frame 18 to enhance the structural integrity and moisture resistance of the internally illuminated panel 10.

FIG. 2 is an exploded cross-sectional view taken through line AA of FIG. 1 illustrating exemplary layers that may be coupled together in a “sandwich” to form the internally illuminated panel 10 described herein. In addition to top layer 12 having indicia 14, panel 10 includes transparent plate 20 having front surface 32 and back surface 30. In most cases, transparent plate 20 may be formed from a thermoplastic polymer, such as a polycarbonate (PC), Polyethylene terephthalate (PET), or acrylic material. As described in more detail below, the thickness of transparent plate 20 is generally dependent on the size of the illumination source embedded therein.

As shown in FIG. 2, channel 16 is formed within one surface (e.g., back surface 30) of the transparent plate, and illumination source 22 is embedded within the channel for illuminating the interior of the transparent plate. In the specific embodiment shown in FIG. 2, channel 16 is formed near the periphery of the transparent plate along its entire circumference (as shown, e.g., in FIG. 1). Alternative locations for channel formation will be discussed in more detail below. Channel 16 may be formed in substantially any manner known in the art (e.g., by etching, routing, etc.). In one embodiment, a computer navigated control (CNC) router may be used to form the channel. In another embodiment, the channel may be formed using a laser or water etch tool. Regardless of the device used to form the channel, it is generally desirable to form the channel as a rectangular-shaped notch.

The width of illumination source 22 dictates the minimum depth of channel 16 as well as the minimum thickness of transparent plate 20. In one embodiment, the width of illumination source 22 may range between about 3 mm and about 7 mm. The depth of the channel should be sufficient to accommodate illumination source 22 without extending through an entire thickness of transparent plate 20. In one embodiment, the thickness of transparent plate 20 may range between about 4 mm and about 8 mm, and the depth of the channel may range between about 3 mm and about 7 mm.

Illumination source 22 is positioned within channel 16 so that light from the source is directed into the transparent plate in a direction substantially parallel to front surface 32 or emitting face of transparent plate 20. In a preferred embodiment, the illumination source includes a string of light emitting diodes (LEDs) mounted along with associated circuitry onto a flexible backing material (such as a flexible PCB material). Such an illumination source is commonly referred to as a “flexible LED strip” or “SMD LED bar.” These sources may be obtained from a variety of manufacturers in varying lengths (e.g., lengths of about 0.3 meters to about 5 meters), colors (e.g., R, G, B, W and Y) and number of LED chips included per interval (e.g., 1, 2 or 3 LED chips per 10-15 mm interval, wherein the number of chips per interval determines the intensity or brightness of the illumination). Depending on the size of the panel or the area of the panel to be illuminated, the flexible LED strips may be cut to a more desirable length.

Several manufacturers offer the flexible LED strips in both waterproof and non-waterproof forms. Non-waterproof strips are generally desired as they consume less space than waterproof strips, which are typically covered with a silicone slipcover. However, it is generally desirable to coat the non-waterproof strip with a waterproofing liquid manufactured specifically for this purpose. After allowing the coated strip to dry for a period of time in a clean room, the coated strip will be substantially impervious to moisture, but will have a lower profile than the waterproof strips currently available from manufacturers.

Internally illuminated panel 10 described herein also includes reflective layer 24 coupled to back surface 30 of transparent plate 20 for reflecting light towards front surface 32 of the plate, and heat conductive layer 26 coupled to reflective layer 24 for conducting heat generated by the illumination source away from the internally illuminated panel. Reflective layer 24 may comprise an optically opaque material or a reflective paint, film or layer. Heat conductive layer 26 may comprise a metal, metal alloy or other thermally conductive material. In addition to heat transfer qualities, heat conductive layer 26 provides the panel with additional structural integrity and environmental protection.

As noted above, transparent layer 28 may be coupled between transparent plate 20 and top layer 12, in some embodiments of the invention. Transparent layer 28 may be used to improve weatherproofing aspects of the panel and/or as a backing layer upon which semi-transparent film 12 (containing, e.g., an image or other indicia to be illuminated) is superimposed. Like layers 12/20, transparent layer 28 may comprise a thermoplastic polymer, such as a polycarbonate (PC), Polyethylene terephthalate (PET), or acrylic material. The thickness of layer 28 may range between about 1 mm and about 5 mm.

As will be described in more detail below, the sandwich layers may be coupled together and sealed against ingress of moisture by use of one or more waterproofing materials. In some embodiments, the sandwich layers may be placed within frame 18, which extends along and covers the peripheral edges of internally illuminated panel 10, as shown in FIGS. 1 and 2. Frame 18 may comprise a metal (e.g., aluminum) or plastic (e.g., ABS) material, and may be sealed to the sandwich layers with a waterproofing material. In other embodiments, frame 18 may be omitted and heat conducting layer 26 may be formed, so as to wrap around the peripheral edges of panel 10.

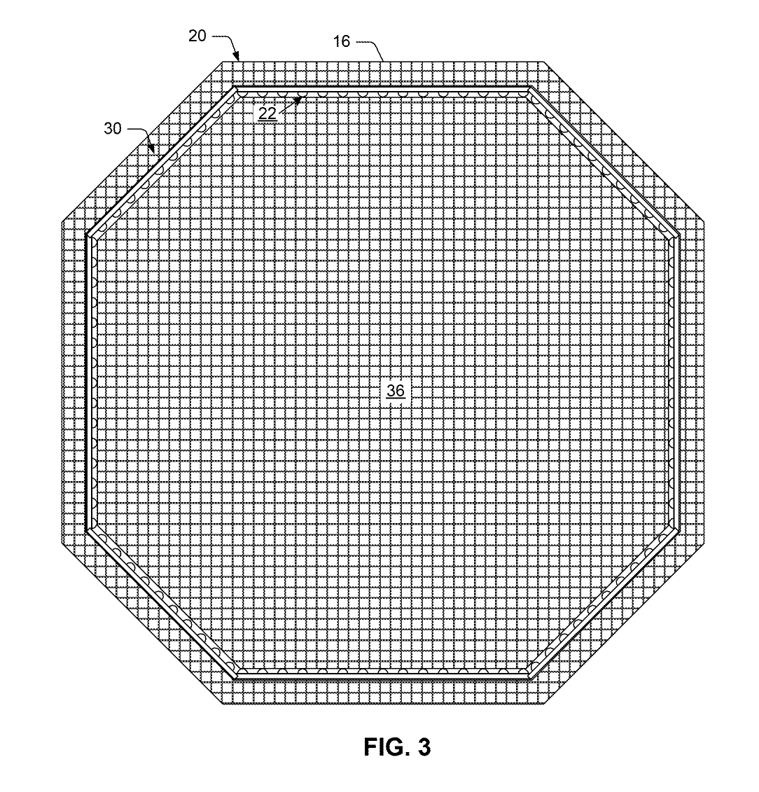

FIG. 3 is a view showing back surface 30 of transparent plate 20 in more detail and in accordance with one embodiment of the invention. As shown in FIG. 3, channel 16 is formed within back surface 30 near the periphery of transparent plate 20 along its entire circumference. Flexible LED strip 22 is embedded within channel and positioned, so that light from the source is directed into the transparent plate (i.e., in a direction substantially parallel to the front and back surfaces of the transparent plate). A pattern of grooves 36 is formed across back surface 30 of the transparent plate for reflecting and refracting the internal illumination in a predetermined and predictable manner. While the grooves may be formed in substantially any manner known in the art (e.g., by etching, routing, etc.), they are generally formed to resemble an inward facing “V” shaped notch as shown, e.g., in FIG. 2. However, the grooves are not limited to any particular shape, and may be alternatively configured in other embodiments of the invention.

In the specific embodiment of FIG. 3, the pattern of grooves 36 extend from opposite sides of back surface 30 of transparent plate 20 in a plurality of evenly spaced rows and columns. While such spacing may be adequate in some embodiments, the intensity of light emitted from front surface 32 of the plate will inherently diminish with increasing orthogonal distance from illumination source 22, as increasingly larger portions of the internal illumination are reflected/refracted out of the plate at regular intervals. Thus, a regular pattern of grooves may not be able to uniformly distribute the illumination across the front face of the plate in all cases.

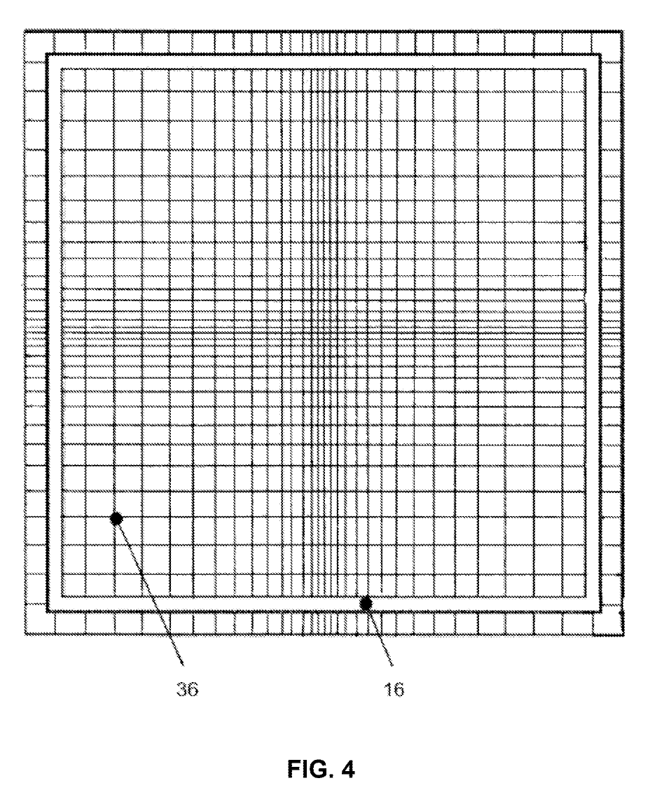

In order to provide uniform distribution of the illumination, a particular spacing of grooves may be selected based on several factors including, but not limited to, the brightness and dispersion angle of the LED light, the shape of the grooves, and the width and thickness of transparent plate 20. In general, however, the spacing between grooves is preferably configured to reflect/refract less light in areas positioned near the illumination source and more light in areas positioned further away from the source (such as near the center of the transparent plate). Stated another way, the spacing between consecutive grooves (e.g., consecutive grooves arranged in rows, or consecutive grooves arranged in columns) preferably decreases with increasing orthogonal distance from the illumination source, as shown in FIG. 4.

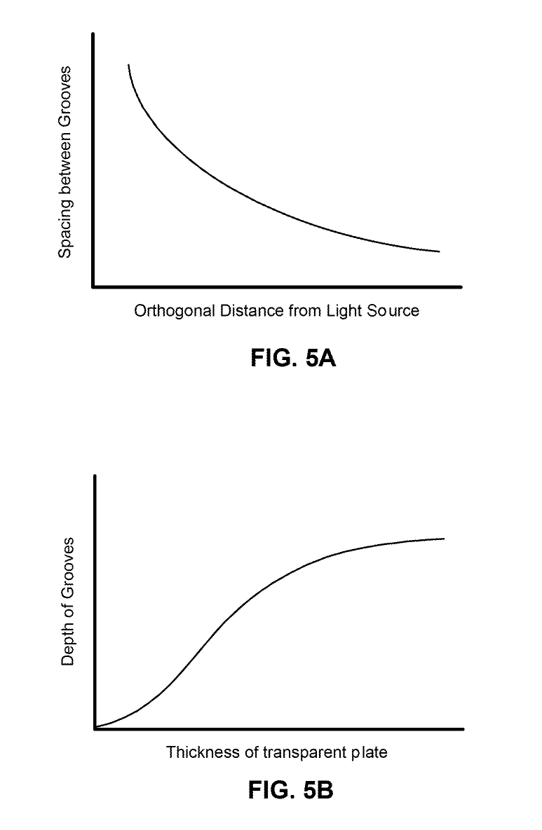

The graph depicted in FIG. 5A illustrates one manner in which the spacing between consecutive grooves may decrease with increasing orthogonal distance from the illumination source. Decreasing the spacing between consecutive grooves provides the advantage of decreasing the amount of light reflected/refracted from areas positioned near the source, and increasing the amount of light reflected/refracted from areas positioned further away from the source. This increases the uniformity of light distribution across the front face of the plate.

To maximize the overall brightness or intensity of light emitted from the front surface of the plate, the depth of the grooves is selected based on the thickness of transparent plate 20. In particular, greater depths are selected for thicker transparent plates, while smaller depths are deemed sufficient for thinner plates. The graph depicted in FIG. 5B illustrates one manner in which the depth of the grooves may increase with increasing thickness of plate 20. Increasing the depth of the grooves enables more light to be “captured” by the grooves, and thus, more light to be reflected/refracted out of the plate. This increases the overall brightness or intensity of light emitted from the front surface of the plate.

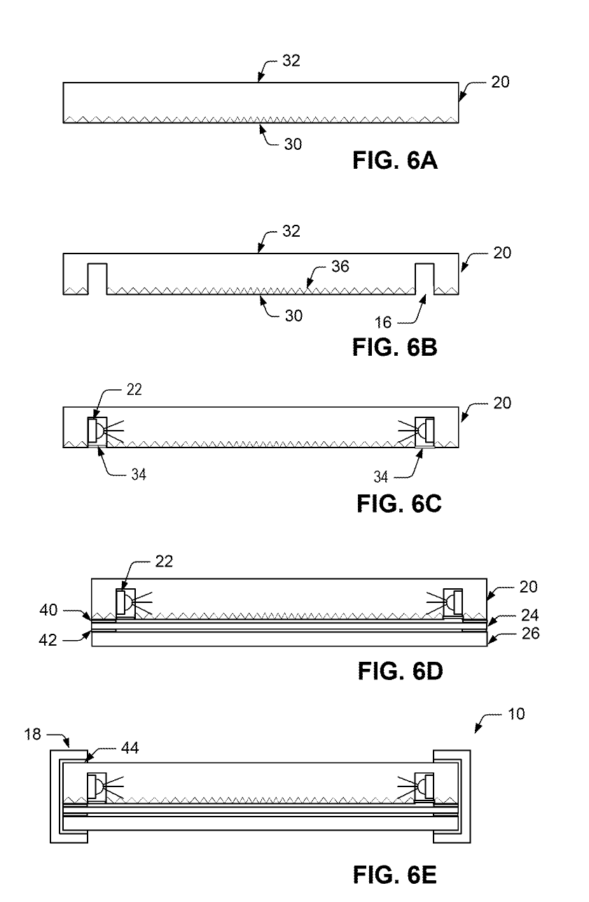

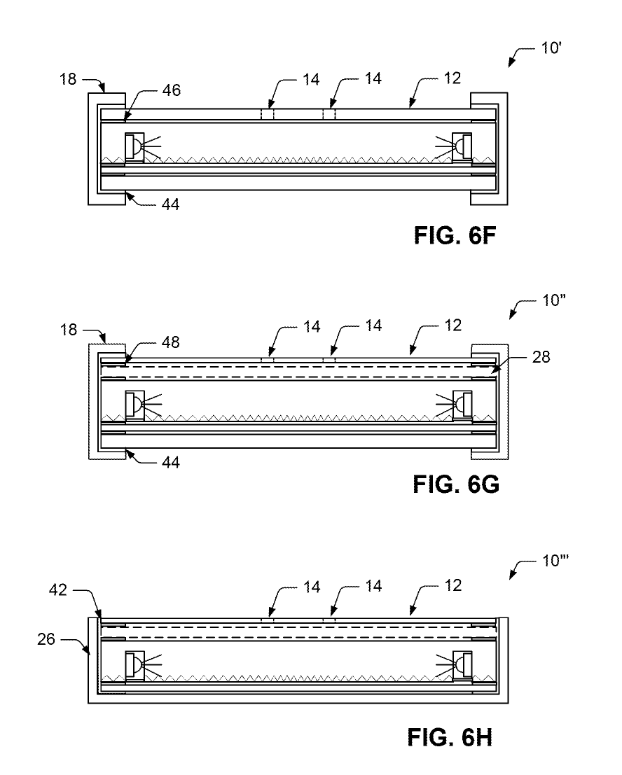

An exemplary method for fabricating internally illuminated panel 10 is illustrated in FIGS. 6A-E according to one embodiment of the invention. The exemplary method is described below in a number of fabrication or manufacturing steps. Some of the steps may be performed in a different order than that specifically described herein. In some embodiments, one or more additional steps may be required to complete the fabrication method. As such, the method described herein is not limited to the particular order of steps noted below, unless otherwise stated herein.

In one embodiment, the method may begin by forming a pattern of grooves 36 within back surface 30 of transparent plate 20, as shown in FIG. 6A. The pattern of grooves may be formed and configured as described above. Next, channel 16 may be formed in the back surface of the transparent plate, as shown in FIG. 6B. The channel may be formed and configured as described above. While it is generally easier from a manufacturing standpoint to form the channel after formation of the grooves, channel formation may be performed prior to, or concurrent with, the formation of the grooves in some embodiments of the invention.

Sometime after the channel and grooves are formed, illumination source 22 may be embedded within the channel, as shown in FIG. 6C. The illumination source is positioned within the channel, such that illumination from the source is directed into transparent plate 20 along a plane substantially parallel to the front and back surfaces of the plate. As noted above, the channel is formed to a depth (d_{CH}), which is sufficient to accommodate illumination source 22 without extending through an entire thickness (t_{TP}) of transparent plate 20. The minimum depth (d_{CH}) of channel 16 as well as the minimum thickness (t_{TP}) of transparent plate 20, therefore, depends on the size of illumination source 22 to be embedded therein.

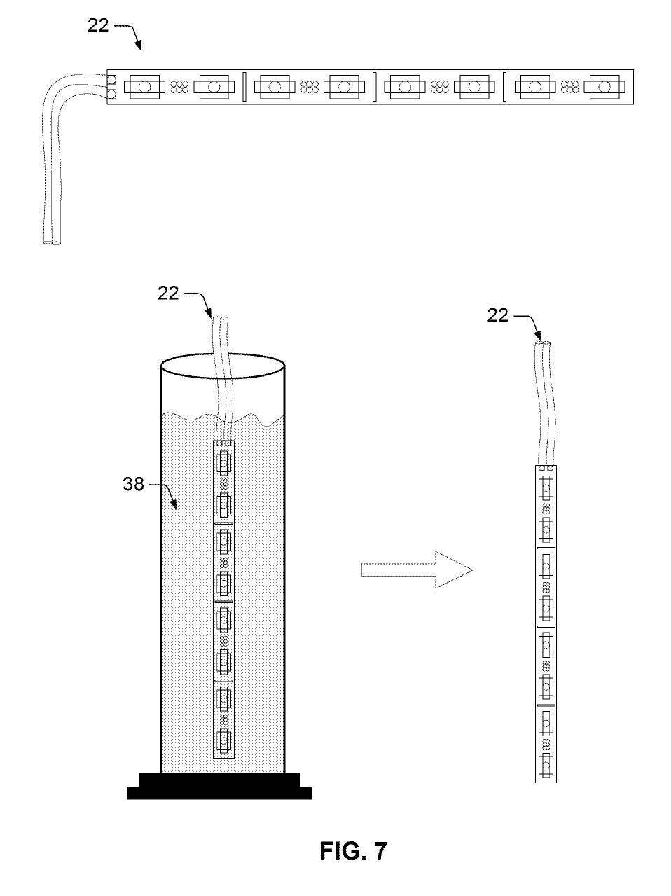

As noted above, illumination source 22 may or may not be waterproof. If a non-waterproof source is used, it is generally desirable to perform a first waterproofing step by coating the illumination source with first waterproof material 38 and allowing the coated illumination source to dry before the illumination source is embedded within the channel. An exemplary method for accomplishing this step is illustrated in FIG. 7. For example, FIG. 7 shows illumination source 22 being dipped into waterproofing liquid 38 and then hung to dry (preferably in a clean room to avoid contaminants). However, the first waterproofing step is not limited to the method shown in FIG. 7, and may be accomplished in accordance with other methods, which result in the illumination source being coated with a relatively thin layer of waterproof material.

After waterproofed illumination source 22 is embedded within channel 16, the entire channel is sealed with second waterproof material 34 in a second waterproofing step, as shown in FIG. 6C. Second waterproof material 34 used to seal the channel may be an adhesive tape, a silicone binder or any other suitable waterproof adhesive material. In some embodiments, second waterproof material 34 may have electrical and/or thermal, as well as adhesive, qualities (such as an electrically or thermally conductive glue or tape). Such qualities may improve heat transfer out of the channel, so that heat generated by the illumination source may be more efficiently removed from the channel.

As shown in FIG. 6D, reflective layer 24 is coupled to back surface 30 of transparent plate 20 using third waterproof material 40, and heat conductive layer 26 is coupled to the reflective layer using fourth waterproof material 42. Like second waterproof material 34, third and fourth waterproof materials 40 and 42, respectively, may be an adhesive tape, a silicone binder or any other suitable waterproof adhesive material. The third and fourth waterproof materials may also be electrically and/or thermally conductive, if so desired.

In some embodiments, fabrication of internally illuminated panel 10 may be substantially completed upon placing the coupled layers 20, 24, and 26 within frame 18, as shown in FIG. 6E. The frame may be configured as described above. In some embodiments, frame 18 may be sealed to the coupled layers with fifth waterproof material 44, which may also be an adhesive tape, a silicone binder or any other suitable waterproof adhesive material. In other embodiments, frame 18 may be attached to the coupled layers without the use of an adhesive (e.g., the frame may be designed to fit snuggly on the peripheral edges the panel).

FIGS. 6F-H provide examples of alternative methods that may be used for fabricating an internally illuminated panel in accordance with the present invention. In most cases, the methods shown in FIGS. 6F-H will include the fabrication steps shown in FIGS. 6A-D. However, additional or alternative steps may be needed to complete the internally illuminated panels shown in FIGS. 6F-H.

FIG. 6F illustrates an embodiment of internally illuminated panel 10′ in which top layer 12 comprising indicia 14 is coupled to panel 10′. Layer 12 and indicia 14 may be formed and configured as described above. As shown in FIG. 6F, layer 12 may be coupled to front surface 32 of transparent plate 20 using sixth waterproof material 46, which may be an adhesive tape, a silicone binder, or any other suitable waterproof adhesive material.

FIG. 6G illustrates an embodiment of the internally illuminated panel 10″ in which transparent layer 28 is coupled between transparent plate 20 and top layer 12. Transparent layer 28 may be used to improve weatherproofing aspects of the panel, and/or as a backing layer upon which semi-transparent film 12 (containing, e.g., an image or other indicia 14 to be illuminated) is superimposed. The transparent layer may be formed and configured as described above. Like the other layers, transparent layer 28 may be coupled between layers 12/20 through the use of seventh waterproofing material 48, which may be an adhesive tape, a silicone binder or any other suitable waterproof adhesive material.

FIG. 6H illustrates an embodiment of the internally illuminated panel 10′″ in which frame 18 is omitted and heat conductive layer 26 is configured to wrap around the peripheral edges of the panel layers. The heat conductive layer 26 may be configured as described above. The heat conductive layer 26 may be coupled to the panel layers using the fourth waterproof material 42 mentioned above.

Various embodiments of an internally illuminated panel have been described herein in reference to FIGS. 1-7. In each the embodiments described above, panel 10 comprises channel 16, which is formed within back surface 30 near the periphery of transparent plate 20 along its entire circumference. While appropriate for smaller designs (e.g., panel sizes up to about 1 m²), such a channel may not enable substantially larger designs to be adequately illuminated, as the area of illumination is inherently limited by the light output provided by the illumination source. In addition, the embodiments shown in FIGS. 1-7 illustrate panel designs, in which illumination is emitted from only one side of the panel.

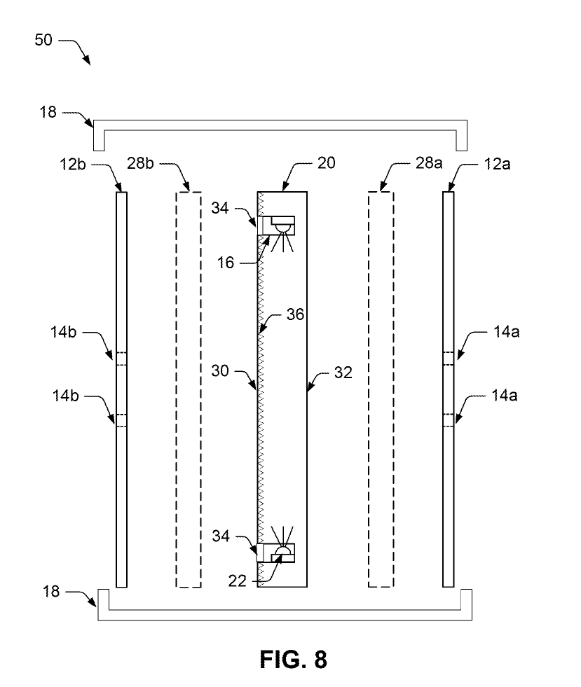

FIG. 8 illustrates one embodiment of internally illuminated panel 50, in which illumination is emitted from both sides of the panel. Panel 50 includes several of the same layers described above and shown in FIG. 2, such as transparent plate 20, top layer 12a having indicia 14a, optional transparent layer 28a, and frame 18. These layers may be formed and configured as described above.

Unlike the one-sided embodiment described above, the dual-sided embodiment shown in FIG. 8 emits illumination from both sides of transparent plate 20. In order to do so, reflective layer 24 and heat conductive layer 26 shown in FIG. 2 are omitted and replaced with bottom layer 12b and optional transparent layer 28b. In some embodiments, layers 12b and 28b may be substantially identical to layers 12a and 28a, in that they may comprise the same material compositions and thicknesses. In some embodiments, indicia 14b included within bottom layer 12b may be substantially identical to indicia 14a included within top layer 12a, such that identical images or designs are displayed on both side of panel 50. In other embodiments, substantially different indicia may be displayed on the opposing sides of the panel.

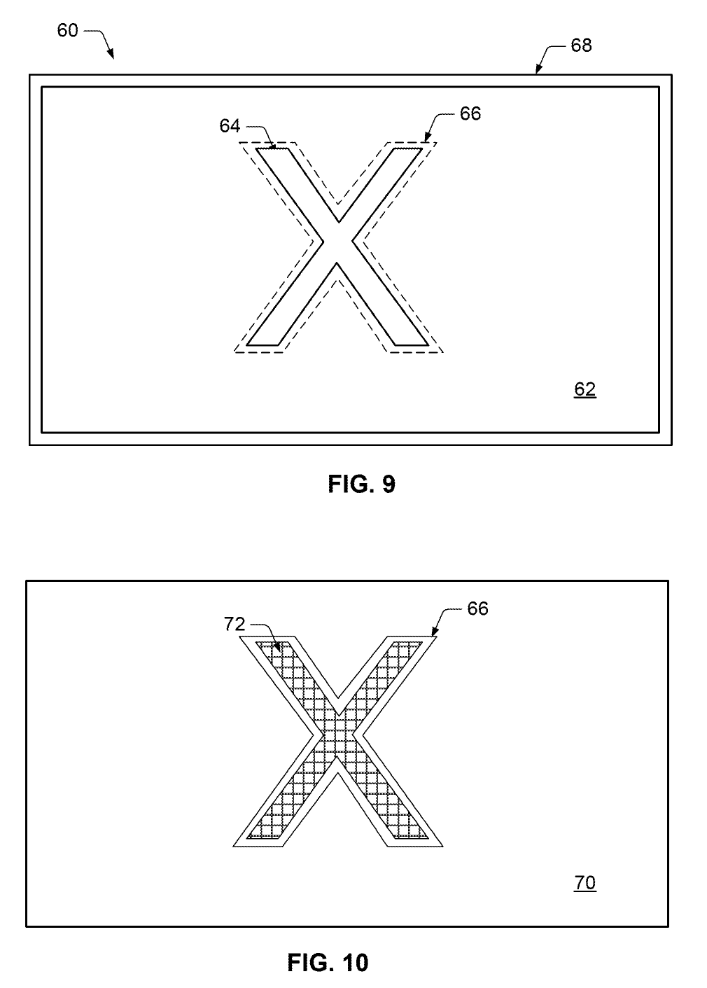

FIGS. 9-10 illustrate one embodiment of internally illuminated panel 60, in which channel 66 is formed within the back surface of transparent plate 70, such that the channel surrounds peripheral edges of indicia 64 to be illuminated, rather than the edges of the panel. This embodiment finds utility in larger panel designs (e.g., panel diameters substantially greater than 1 m²), which cannot be successfully illuminated by a circumferentially embedded illumination source.

A front face of panel 60 is depicted in FIG. 9 as including top layer 62 having indicia 64 (in this case, an “X”), which is illuminated by an illumination source (not shown) embedded within channel 66 formed within transparent plate 70. Top layer 62 and indicia 64 may be formed and configured as described above. Top layer 62 and transparent plate 70 may be coupled together with one or more layers to form a “sandwich” of similarly shaped layers. In some embodiments, the “sandwich” of layers may be encased within frame 68 to enhance the structural integrity and moisture resistance of internally illuminated panel 60.

FIG. 10 is a view showing the back surface of transparent plate 70 in accordance with one embodiment of the invention. As shown in FIG. 10, channel 66 is formed around peripheral edges of indicia 64 to be illuminated, rather than the edges of panel 60. An illumination source is embedded within channel 66 and positioned so that light from the source is directed into only the portions of the transparent plate comprising the indicia. This reduces the area, which must be illuminated by the source, rendering such a design suitable for larger panels (i.e., panels substantially larger than 1 m²).

As in the previous embodiments, a pattern of grooves 72 is formed across the back surface of transparent plate 70 for reflecting and refracting the internal illumination in a predetermined and predictable manner. The pattern or grooves 72 may be formed and configured as described above. However, grooves 72 may generally differ from grooves 36, in that grooves 72 are only formed in areas of the transparent plate 70 underlying indicia 64 formed in top layer 64. This advantageously reduces the amount of etching needed to form grooves 72.

It will be appreciated to those skilled in the art having the benefit of this disclosure that this invention is believed to provide an internally illuminated panel, which overcomes the disadvantages of currently available panels. Further modifications and alternative embodiments of various aspects of the invention will be apparent to those skilled in the art in view of this description. It is intended, therefore, that the following claims be interpreted to embrace all such modifications and changes and, accordingly, the specification and drawings are to be regarded in an illustrative rather than a restrictive sense.

What is claimed is:

1. An internally illuminated panel, comprising:
a transparent plate having a front surface and a back surface, wherein the transparent plate comprises:
a channel formed within the back surface of the transparent plate;
an illumination source embedded within the channel for directing illumination into an interior of the transparent plate; and
a pattern of grooves formed across the back surface for reflecting and refracting the internal illumination in a predetermined and predictable manner, wherein characteristics of the pattern are configured to provide uniform distribution and intensity of the internal illumination emitted from the front surface of the transparent plate.

2. The internally illuminated panel as recited in claim 1, wherein the channel is formed near peripheral edges of the transparent plate along an entire circumference of the back surface.

3. The internally illuminated panel as recited in claim 1, wherein the illumination source comprises a string of light emitting diodes (LEDs) mounted onto a flexible backing material.

4. The internally illuminated panel as recited in claim 1, wherein the grooves extend from opposite sides of the back surface in a plurality of rows and columns.

5. The internally illuminated panel as recited in claim 1, wherein the characteristics of the pattern comprise a spacing between consecutive grooves, and wherein the spacing decreases with increasing orthogonal distance from the illumination source.

6. The internally illuminated panel as recited in claim 1, wherein the characteristics of the pattern comprise a depth of the grooves, and wherein the depth of the grooves is based on a thickness of the transparent plate.

7. The internally illuminated panel as recited in claim 1, further comprising a reflective layer coupled to the back surface of the transparent plate for reflecting portions of the internal illumination towards the front surface of the transparent plate.

8. The internally illuminated panel as recited in claim 7, further comprising a heat conductive layer coupled to the reflective layer for conducting heat generated by the illumination source away from the internally illuminated panel.

9. The internally illuminated panel as recited in claim 8, further comprising means for weatherproofing the internally illuminated panel, wherein said means comprise:
a first waterproof material coating the illumination source;
a second waterproof material covering the channel and the illumination source embedded therein;
a third waterproof material for coupling the reflective layer to the back surface of the transparent plate; and
a fourth waterproof material for coupling the heat conductive layer to the reflective layer.

10. The internally illuminated panel as recited in claim 9, further comprising an top layer coupled to the front surface of the transparent plate, wherein the top layer comprises indicia configured for selectively transmitting the illumination emitted from the front surface.

11. The internally illuminated panel as recited in claim 10, wherein said means for weatherproofing further comprise a fifth waterproof material used to couple the top layer to the front surface of the transparent plate.

12. The internally illuminated panel as recited in claim 10, wherein the channel is formed within the back surface of the transparent plate surrounding peripheral edges of the indicia in the top layer.

13. An internally illuminated panel, comprising:
a transparent plate comprising an illumination source embedded within a channel formed within one surface of the transparent plate, wherein the one surface comprises a pattern of grooves configured to distribute illumination, which is directed into the transparent plate by the illumination source, uniformly across an opposite surface of the transparent plate;
a reflective layer coupled to the one surface for reflecting portions of the internal illumination towards the opposite surface of the transparent plate;
a heat conductive layer coupled to the reflective layer for conducting heat generated by the illumination source away from the internally illuminated panel; and
means for weatherproofing the internally illuminated panel, wherein said means for weatherproofing comprise:
a first waterproof material coating the illumination source;
a second waterproof material covering the channel and the illumination source embedded therein;
a third waterproof material for coupling the reflective layer to the one surface of the transparent plate; and
a fourth waterproof material for coupling the heat conductive layer to the reflective layer.

14. The internally illuminated panel as recited in claim 13, further comprising a top layer coupled to the opposite surface of the transparent plate, wherein the top layer comprises indicia configured for selectively transmitting illumination emitted from the opposite surface.

15. The internally illuminated panel as recited in claim 14, wherein said means for weatherproofing further comprise a fifth waterproof material for coupling the top layer to the opposite surface of the transparent plate.

16. A method for manufacturing an internally illuminated panel, the method comprising:
forming a pattern of grooves within a back surface of a transparent plate;
forming a channel within the back surface of the transparent plate;
embedding an illumination source within the channel, such that illumination from the source is directed into the transparent plate along a plane substantially parallel to the back surface;
sealing the channel with a first waterproof material after the illumination source has been embedded therein;
coupling a reflective layer to the back surface of the transparent plate using a second waterproof material; and
coupling a heat conductive layer to the reflective layer using a third waterproof material.

17. The method as recited in claim 16, wherein prior to the step of embedding the illumination source, the method further comprises coating the illumination source with a waterproof liquid and allowing the coated illumination source to dry.

18. The method as recited in claim 16, further comprising coupling a top layer to a front surface of the transparent plate using a fourth waterproof material, wherein the top layer comprises indicia configured for selectively transmitting illumination emitted from the front surface.

19. The method as recited in claim 16, wherein the step of forming a pattern of grooves comprises etching the grooves across the back surface, such that the grooves extend from opposite edges of the back surface in a plurality of rows and columns.

20. The method as recited in claim 19, wherein the step of forming a pattern of grooves comprises etching the grooves, such that a spacing between consecutive grooves decreases with increasing orthogonal distance from the illumination source.

21. The method as recited in claim 19, wherein the step of forming a pattern of grooves comprises etching the grooves to a depth dependent on a thickness of the transparent plate.
